(19) United States
(12) Patent Application Publication
(10) Pub. No.: US 2015/0142648 A1
(43) Pub. Date: May 21, 2015

(54) Corporate Bill Self-service System with Blank Bill Vending and Temporary Bill Storage Functions

(71) Applicants: Jian Bu, Chengdu (CN); An Luo, Chengdu (CN); Shaochuan Feng, Chengdu (CN); Huifang Yang, Chengdu (CN); Mingyuan Luo, Chengdu (CN); Xiaoling Wang, Chengdu (CN); Xiaobo Li, Chengdu (CN); Wanbin Xie, Chengdu (CN)

(72) Inventors: Jian Bu, Chengdu (CN); An Luo, Chengdu (CN); Shaochuan Feng, Chengdu (CN); Huifang Yang, Chengdu (CN); Mingyuan Luo, Chengdu (CN); Xiaoling Wang, Chengdu (CN); Xiaobo Li, Chengdu (CN); Wanbin Xie, Chengdu (CN)

(73) Assignee: CHENGDU SANTAI ELECTRONIC INDUSTRY CO., LTD., Chengdu, Sichuan (CN)

(21) Appl. No.: 14/391,093

(22) PCT Filed: Aug. 22, 2012
(86) PCT No.: PCT/CN2012/080456

§ 371 Date: Oct. 7, 2014

(30) Foreign Application Priority Data
Apr. 26, 2012 (CN) 201210126597.5

(51) Int. Cl. G06Q 20/14; G06K 9/00; G06K 9/18

(52) U.S. Cl. CPC G06Q 20/14; G06K 9/186; G06K 9/00469
USPC 705/40

(57) ABSTRACT

The invention solves present problems of insufficient flexibility and convenience and inefficiency in processing of corporate bill businesses, and provides a corporate bill self-service system with functions of blank bill selling and temporary bill storage, and the technical solution thereof can be summarized as follows: the corporate bill self-service system with functions of blank bill selling and temporary bill storage consists of a business self-service center platform and at least a front-end corporate bill self-service terminal which are connected with each other; the corporate bill business self-service centre platform is used for providing entry of system basic platform building information, data storage, equipment monitoring, optical character recognition (OCR), interface with an external system and system data inquiry statistics management; and the front-end corporate bill self-service terminal is used for storing corporate bills, recovering invalidated corporate bills, achieving interaction with users, and acquiring and identifying key information of corporate bills.

### FIELD OF THE INVENTION

The invention relates to an automation technology, in particular to an automatic bank corporate bill processing technology.

### DESCRIPTION OF THE RELATED ART

In recent years, the People's Bank of China has gradually established and successfully promoted and run an imaging technology-based corporate bill image exchange system on a national scale. The system supports nationwide use of corporate bills. On such basis, the corporate bill business volume grows stably, and increase in the corporate bill business volume results in increased pressure on bank counters. How to use self-service equipment to reduce pressure on the counters becomes a concern of all commercial banks. At present, there are at least five problems in corporate bill processing business flow of bank enterprises: 1. the corporate bills of bank enterprises are generally sold to the customers in such a manner that customer accountants arrive at the bank enterprises regularly to get the corporate bills, lacking flexibility and convenience; 2.

the corporate bills are processed in a semi-manual state, and corporate bill image, data checking, data processing and data storage must need manual operations in different periods, resulting in long-term low efficiency; 3. processing of invalidated corporate bills has poor flexibility; 4. a uniform platform is not available for data management, resulting in impossibility in real-time monitoring of system basic information management, setting of system parameters, management of equipment and instruments at outlets, operating state of equipment at outlets, and business acceptance statistics; and 5. nationwide settlement of corporate bill business cannot be automatically achieved. The corporate bills herein comprise checks, receipts and drafts.

### SUMMARY OF THE INVENTION

The technical problem to be solved by the invention is to solve existing defects of insufficient flexibility and convenience and low security in processing corporate bills business, and provide a corporate bill self-service system with blank bill selling and temporary bill storage functions.

A technical solution for solving the technical problem in the invention is a corporate bill self-service system with blank bill selling and temporary bill storage functions, characterized by comprising a corporate bill business self-service center platform and at least one front-end corporate bill self-service terminal, and the corporate bill business self-service center platform being connected with the at least one front-end corporate bill self-service terminal;

the corporate bill business self-service center platform being used for providing entry of system basic platform building information, data storage, equipment monitoring, optical character recognition (OCR), interface with an external system and system data inquiry statistics management; and

the front-end corporate bill self-service terminal being used for storing corporate bills, recovering invalidated corporate bills, achieving interaction with users, and acquiring and identifying key information of corporate bills.

In particular, the acquisition and identification of key information of corporate bills comprises corporate bill image collection, corporate bill authenticity identification and corporate bill element entry.

Further, the corporate bill business self-service center platform comprises a corporate bill business management module, a corporate bill business service module, a corporate bill business identification encryption module, a corporate bill business interface module, a database, a blank corporate bill selling module and an invalidated corporate bill recovery module, the corporate bill business management module is connected with the database, the corporate bill business service module is connected with the database and the corporate bill business interface module, the corporate bill business identification encryption module is connected with the corporate bill business service module, and the blank bill selling module and the invalidated corporate bill recovery module are connected with the database respectively;

the corporate bill business management module is used for management of basic information of the overall system, system parameter setting and the front-end corporate bill self-service terminal, as well as real-time monitoring of running status of the front-end corporate bill self-service terminal, and business acceptance statistics;

the corporate bill business service module is used for realizing data interaction between the front-end corporate bill self-service terminal and the corporate bill business self-service center platform;

the corporate bill business identification encryption module is used for realizing encrypted storage of key elements of corporate bills using OCR technology and an encryption algorithm;

the corporate bill business interface module is used for connecting the front-end corporate bill self-service terminal;

the blank corporate bill selling module is used for controlling the front-end corporate bill self-service terminal to realize the blank corporate bill selling and business counting and recording thereof, corporate bill selling information management, printing and inquiry functions, and has corresponding customer management function;

the invalidated corporate bill recovery module is used for counting and recording invalidated corporate bills found in manual secondary review process, providing customer accounts corresponding to the invalidated corporate bills and corresponding recovery box numbers in the front-end corporate bill self-service terminal corresponding to the customer accounts, providing invalidated corporate bill printing and inquiry functions, and has corresponding customer management function; and

the database is used for storing all kinds of data information.

In particular, the key elements comprise two-dimensional codes and magnetic codes on the surfaces of corporate bills.

Further, the front-end corporate bill self-service terminal comprises a terminal host, a front-end interface, a corporate bill storage box, a corporate bill clearing box, a recovery box and a corporate bill processing module, the corporate bill processing module is connected with the terminal host, the corporate bill storage box is connected with the corporate bill clearing box, the corporate bill storage box and the corporate bill clearing box are connected with the terminal host respectively, the recovery box is connected with the terminal host, and the terminal host is connected to a private banking network through the front-end interface, and then connected to the corporate bill business interface module of the corporate bill business self-service center platform via the private network;

the terminal host is used for control of all modules connected thereto and interacts with the corporate bill business self-service center platform through the front-end interface;

the corporate bill storage box is used for storing blank corporate bills;

the corporate bill clearing box is used for providing corporate bills for users and/or returning invalidated corporate bills to users;

the recovery box is used by workers to put invalidated corporate bills of the customer accounts corresponding to the recovery box; and

the corporate bill processing module is used for corporate bill scanning, OCR of corporate bills and receipt printing, controlling the corporate bill storage box to extract blank corporate bills to the corporate bill clearing box and transact to users, and sending information of sold and processed corporate bills to the corporate bill business self-service center platform through the terminal host.

In particular, the recovery box is equipped with a recovery box security gate and an interaction module which are connected with the terminal host respectively, and the security gate is controlled by the terminal host; and

the interaction module is used by the customers to enter passwords or insert customer cards.

Further, the corporate bill processing module comprises a corporate bill information print module, an OCR module, a corporate bill information scanning module and a receipt print module, the corporate bill information print module is connected with the terminal host, the OCR module is connected with the terminal host, the corporate bill information scanning module is connected with the terminal host, and the receipt print module is connected with the terminal host;

the corporate bill information print module is used for printing required corporate bill face information;

the corporate bill information scanning module is used for scanning front and back images and UV images (ultraviolet images) of corporate bills;

the OCR module is used for OCR of corporate bills; and

the receipt print module is used for self-service printing of recovery slips and deposit receipts.

In particular, the corporate bill clearing box is also equipped with a security gate which is connected with the terminal host and controlled by the terminal host.

Further, the corporate bills comprise checks and/or receipts and/or drafts.

The beneficial effects of the invention are as follows: with the corporate bill self-service system with blank bill selling and temporary bill storage functions, users are relieved from purchasing corporate bills at the counter of any bank; the invalidated corporate bills can be returned to users immediately, and the automatic scanning and other data processing and storage of corporate bills as well as management and counting of invalidated corporate bills can be realized to comprehensively improve the work efficiency of bank enterprises; in addition, customers can get respective invalidated corporate bills from the corresponding recovery boxes immediately, which provides convenience for users.

### BRIEF DESCRIPTION OF THE DRAWINGS

FIG. 1 is a system block diagram of the embodiment.

### DESCRIPTION OF THE PREFERRED EMBODIMENT

The technical solution of the invention will be described in detail in combination with the accompanying drawing and embodiment.

The corporate bill self-service system with blank bill selling and temporary bill storage functions of the invention consists of a corporate bill business self-service center platform and at least one front-end corporate bill self-service terminal which are connected with each other, in which the corporate bill business self-service centre platform is used for providing entry of system basic platform building information, data storage, equipment monitoring, optical character recognition (OCR), interface with an external system and system data inquiry statistics management, and the front-end corporate bill self-service terminal is used for storing corporate bills, recovering invalidated corporate bills, achieving interaction with users, and acquiring and identifying key information of corporate bills, so that the corporate bill business can be as automated as possible, thus facilitating users and enhancing work efficiency of bank enterprises.

### EMBODIMENT

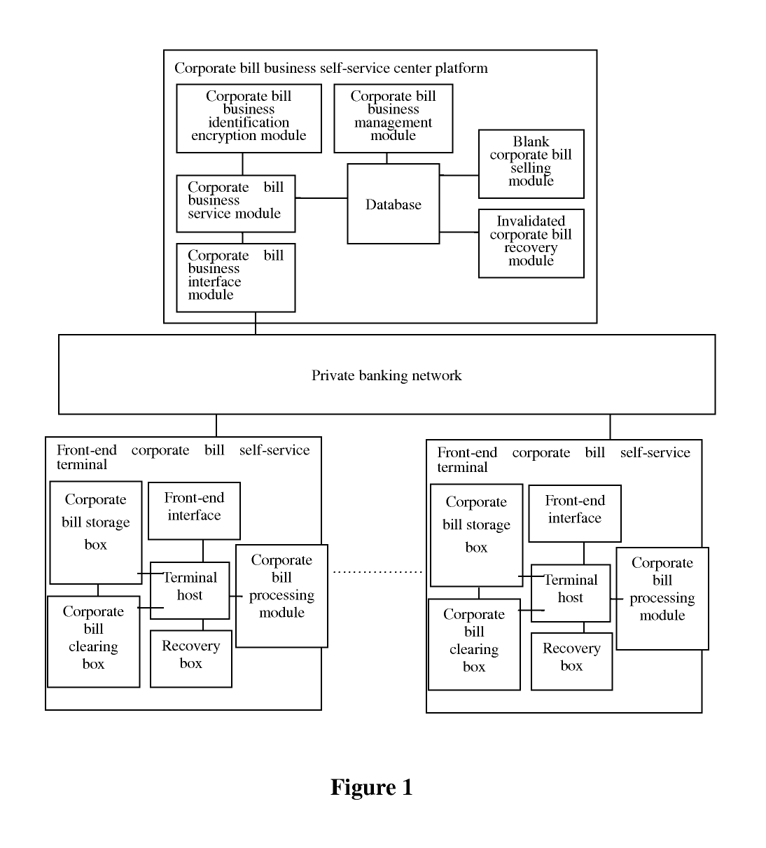

In the embodiment, the corporate bill business self-service center platform comprises a corporate bill business management module, a corporate bill business service module, a corporate bill business identification encryption module, a corporate bill business interface module, a blank corporate bill selling module and an invalidated corporate bill recovery module; the front-end corporate bill self-service terminal comprises a terminal host, a front-end interface, a corporate bill storage box, a corporate bill clearing box, a recovery box and a corporate bill processing module. The system block diagram thereof is shown in FIG. 1.

Firstly, a corporate bill business self-service center platform and at least one front-end corporate bill self-service terminal are connected to obtain the corporate bill self-service system with blank bill selling and temporary bill storage functions, in which the corporate bill business self-service centre platform is used for providing entry of system basic platform building information, data storage, equipment monitoring, optical character recognition (OCR), interface with an external system and system data inquiry statistics management; and the front-end corporate bill self-service terminal is used for storing corporate bills, recovering invalidated corporate bills, achieving interaction with users, and acquiring and identifying key information of corporate bills. The acquisition and identification of key information of corporate bills comprise corporate bill image collection, corporate bill authenticity identification and corporate bill element entry; and the corporate bills comprise checks and/or receipts and/or drafts.

The corporate bill business self-service center platform consists of a corporate bill business management module, a corporate bill business service module, a corporate bill business identification encryption module, a corporate bill business interface module, a database, a blank corporate bill selling module and an invalidated corporate bill recovery module. The corporate bill business management module is connected with the database, the corporate bill business service module is connected with the database and the corporate bill business interface module, the corporate bill business identification encryption module is connected with the corporate bill business service module, and the blank bill sending module and the invalidated corporate bill recovery module are connected with the database respectively, in which the corporate bill business management module is used for management of basic information of the overall system, system parameter setting and the front-end corporate bill self-service terminal, as well as real-time monitoring of running status of the front-end corporate bill self-service terminal and business acceptance statistics; the corporate bill business service module is used for realizing data interaction between the front-end corporate bill self-service terminal and the corporate bill business self-service center platform; the corporate bill selling identification encryption module is used for realizing encrypted storage of key elements of corporate bills using OCR technology and an encryption algorithm, and the key elements comprise two-dimensional codes and magnetic codes on the surfaces of corporate bills; the corporate bill business interface module is used for connecting the front-end corporate bill self-service terminal; the blank corporate bill selling module is used for controlling the front-end corporate bill self-service terminal to realize the blank corporate bill selling and business counting and recording thereof, corporate bill selling information management, printing and inquiry functions, and has corresponding customer management function; the invalidated corporate bill recovery module is used for counting and recording invalidated corporate bills found in manual secondary review process, providing customer accounts corresponding to the invalidated corporate bills and corresponding recovery box numbers in the front-end corporate bill self-service terminal corresponding to the customer accounts, providing invalidated corporate bill printing and inquiry functions, and has corresponding customer management function; and the database is used for storing all kinds of data information.

The front-end corporate bill self-service terminal is connected with the terminal host by the corporate bill processing module, the corporate bill storage box is connected with the corporate bill clearing box, the corporate bill storage box and the corporate bill clearing box are connected with the terminal host respectively, and the recovery box is connected with the terminal host, in which the terminal host is connected to a private banking network by the front-end interface and connected to the corporate bill business interface module of the corporate bill business self-service center platform by the private network; the terminal host is used for control of all modules connected thereto and interacts with the corporate bill business self-service center platform through the front-end interface; the corporate bill storage box is used for storing blank corporate bills; the corporate bill clearing box is used for providing corporate bills for users and/or returning invalidated corporate bills to users, the invalidated corporate bills herein mean the corporate bills which are wrongly completed by users and considered to be the invalidated ones by the front-end corporate bill self-service terminal, and the corporate bill clearing box is also equipped with a security gate which is connected with the terminal host and controlled by the terminal host; the recovery box is used by workers to for put invalidated corporate bills of the customer accounts corresponding to the recovery box, the recovery box is equipped with a recovery box security gate and an interaction module which are connected with the terminal host respectively, the security gate is controlled by the terminal host, and the interaction module is used by the customers to enter passwords or insert customer cards, and the terminal host transmits passwords or information of the customer card input by the customers to the corporate bill business self-service center platform for verification, then the security gate of the recovery box is opened under control after passing verification; the corporate bill processing module is used for corporate bill scanning, OCR of corporate bills and receipt printing so as to control the corporate bill storage box to extract blank corporate bills to the corporate bill clearing box and then to users, and sending information of sold and processed corporate bills to the corporate bill business self-service center platform through the terminal host; the corporate bill processing module consists of a corporate bill information print module, an OCR module, a corporate bill information scanning module and a receipt print module; the corporate bill information print module is connected with the terminal host, the OCR module is connected with the terminal host, the corporate bill information scanning module is connected with the terminal host, and the receipt print module is connected with the terminal host; herein the corporate bill information print module is used for printing required corporate bill face information; the corporate bill information scanning module is used for scanning front and back images and UV images (ultraviolet images) of corporate bills; the OCR module is used for OCR of the corporate bills; and the receipt print module is used for printing self-service recovery slips and deposit receipts.

1. A corporate bill self-service system with blank bill selling and temporary bill storage functions, characterized by comprising a corporate bill business self-service center platform and at least one front-end corporate bill self-service terminal, and the corporate bill business self-service center platform being connected with the at least one front-end corporate bill self-service terminal;
the corporate bill business self-service center platform being used for providing entry of system basic platform building information, data storage, equipment monitoring, optical character recognition (OCR), interface with an external system and system data inquiry statistics management; and
the front-end corporate bill self-service terminal being used for storing corporate bills, recovering invalidated corporate bills, achieving interaction with users, and acquiring and identifying key information of corporate bills.

2. The corporate bill self-service system with blank bill selling and temporary bill storage functions of claim 1, characterized in that the acquisition and identification of key information of corporate bills comprises corporate bill image collection, corporate bill authenticity identification and corporate bill element entry.

3. The corporate bill self-service system with blank bill selling and temporary bill storage functions of claim 1, characterized in that the corporate bill business self-service center platform comprises a corporate bill business management module, a corporate bill business service module, a corporate bill business identification encryption module, a corporate bill business interface module, a database, a blank corporate bill selling module and an invalidated corporate bill recovery module, the corporate bill business management module is connected with the database, the corporate bill business service module is connected with the database and the corporate bill business interface module,
the corporate bill business identification encryption module is connected with the corporate bill business service module, and the blank bill selling module and the invalidated corporate bill recovery module are connected with the database respectively;
the corporate bill business management module is used for management of basic information of the overall system, system parameter setting and the front-end corporate bill self-service terminal, as well as real-time monitoring of running status of the front-end corporate bill self-service terminal, and business acceptance statistics;
the corporate bill business service module is used for realizing data interaction between the front-end corporate bill self-service terminal and the corporate bill business self-service center platform;
the corporate bill business identification encryption module is used for realizing encrypted storage of key elements of corporate bills using OCR technology and an encryption algorithm;
the corporate bill business interface module is used for connecting the front-end corporate bill self-service terminal;
the blank corporate bill selling module is used for controlling the front-end corporate bill self-service terminal to realize the blank corporate bill selling and business counting and recording thereof, corporate bill selling information management, printing and inquiry functions, and has corresponding customer management function;
the invalidated corporate bill recovery module is used for counting and recording invalidated corporate bills found in manual secondary review process, providing customer accounts corresponding to the invalidated corporate bills and corresponding recovery box numbers in the front-end corporate bill self-service terminal corresponding to the customer accounts, providing invalidated corporate bill printing and inquiry functions, and has corresponding customer management function; and
the database is used for storing all kinds of data information.

4. The corporate bill self-service system with blank bill selling and temporary bill storage functions of claim 3, characterized in that the key elements comprise two-dimensional codes and magnetic codes on the surfaces of corporate bills.

5. The corporate bill self-service system with blank bill selling and temporary bill storage functions of claim 1, characterized in that the front-end corporate bill self-service terminal comprises a terminal host, a front-end interface, a corporate bill storage box, a corporate bill clearing box, a recovery box and a corporate bill processing module, the corporate bill processing module is connected with the terminal host, the corporate bill storage box is connected with the corporate bill clearing box, the corporate bill storage box and the corporate bill clearing box are connected with the terminal host respectively, the recovery box is connected with the terminal host, and the terminal host is connected to a private banking network through the front-end interface, and then connected to the corporate bill business interface module of the corporate bill business self-service center platform via the private network;
the terminal host is used for control of all modules connected thereto and interacts with the corporate bill business self-service center platform through the front-end interface;
the corporate bill storage box is used for storing blank corporate bills;
the corporate bill clearing box is used for providing corporate bills for users and/or returning invalidated corporate bills to users;
the recovery box is used by workers to put invalidated corporate bills of the customer accounts corresponding to the recovery box; and
the corporate bill processing module is used for corporate bill scanning, OCR of corporate bills and receipt printing, controlling the corporate bill storage box to extract blank corporate bills to the corporate bill clearing box and transact to users, and sending information of sold and processed corporate bills to the corporate bill business self-service center platform through the terminal host.

6. The corporate bill self-service system with blank bill selling and temporary bill storage functions of claim 5, characterized in that the recovery box is equipped with a recovery box security gate and an interaction module which are connected with the terminal host respectively, and the security gate is controlled by the terminal host; and
the interaction module is used by the customers to enter passwords or insert customer cards.

7. The corporate bill self-service system with blank bill selling and temporary bill storage functions of claim 5, characterized in that the corporate bill processing module comprises a corporate bill information print module, an OCR module, a corporate bill information scanning module and a receipt print module, the corporate bill information print module is connected with the terminal host, the OCR module is connected with the terminal host, the corporate bill information scanning module is connected with the terminal host, and the receipt print module is connected with the terminal host;
the corporate bill information print module is used for printing required corporate bill face information;
the corporate bill information scanning module is used for scanning front and back images and UV images (ultraviolet images) of corporate bills;
the OCR module is used for OCR of corporate bills; and
the receipt print module is used for self-service printing of recovery slips and deposit receipts.

8. The corporate bill self-service system with blank bill selling and temporary bill storage functions of claim 7, characterized in that the corporate bill clearing box is also equipped with a security gate which is connected with the terminal host and controlled by the terminal host.

9. The corporate bill self-service system with blank bill selling and temporary bill storage functions of claim 1, characterized in that the corporate bills comprise checks and/or receipts and/or drafts.
